(19) United States
(12) Patent Application Publication
(10) Pub. No.: US 2008/0041356 A1
(43) Pub. Date: Feb. 21, 2008

(54) Steam Discharge Device for Pressure Cooker

(75) Inventor: Hwa-Baek Seo, Incheon (KR)

Correspondence Address: SHERIDAN ROSS PC, 1560 BROADWAY, SUITE 1200, DENVER, CO, 80202, US

(73) Assignee: SAEKWANG ALUMINIUM CO., LTD., Ansan-si (KR)

(21) Appl. No.: 11/572,171

(22) PCT Filed: Jul. 28, 2005
(86) PCT No.: PCT/KR05/02457

§ 371 Date: Jan. 16, 2007

(30) Foreign Application Priority Data
Jul. 30, 2004 (KR) 20-2004-0021816

(51) Int. Cl. A21B 1/08

(52) U.S. Cl. 126/20

(57) ABSTRACT

Disclosed herein is a steam discharge device for pressure cookers. The steam discharge device includes a steam pipe, a fastening nut, a safety cap, and an O-ring. The steam pipe has a first steam discharge passage, with an external thread provided on an outer circumference of an end of the steam pipe, and a locking step provided on a middle of the steam pipe. The fastening nut includes a second steam discharge passage, and an internal thread provided in the fastening nut and engaging with the external thread of the steam pipe. The safety cap includes a nut receiving space, and a plurality of slots provided at a predetermined position on the safety cap and enabling the nut receiving space to communicate with the exterior. The O-ring is positioned between the fastening nut and the safety cap, and prevents the safety cap from being removed from the fastening nut.

### TECHNICAL FIELD

The present invention relates, in general, to a steam discharge device for pressure cookers and, more particularly, to a steam discharge device for a pressure cooker, which is constructed so that a steam pipe for discharging steam from the interior of the pressure cooker is fastened to a fastening nut, and a safety cap is detachably fastened to the fastening nut via an O-ring fitted over the outer circumference of the fastening nut, thus enlarging a space for discharging steam from the pressure cooker, therefore reducing dangers, such as the risk of explosion.

### BACKGROUND ART

As shown in FIGS. 1 and 2, a conventional steam discharge device 1 for pressure cookers includes a steam pipe 2 and a safety cap 3. A steam discharge passage 2-1 is defined in the steam pipe 2 such that steam passes through the steam discharge passage 2-1. An external thread 2-2 is provided on the outer circumference of an end of the steam pipe 2, and a locking step 2-3 is provided on the outer circumference of the middle of the steam pipe 2. Further, an internal thread 3-1 is provided on an inner surface of the safety cap 3 to correspond to the external thread 2-2. A plurality of slots 3-2 is formed in the safety cap 3 at regular intervals so that the steam passes through the slots.

The process of installing the conventional steam discharge device 1 on a pressure cooker 5 will be described below.

First, a pressure regulator 4 is mounted to the upper portion of the steam pipe 2. The lower portion of the steam pipe 2 having the external thread 2-2 is inserted into a mounting hole 7 which is formed on a lid 6 of the pressure cooker 5. Next, the steam pipe 2 is fastened to the safety cap 3 such that the external thread 2-2 of the steam pipe 2 engages with the internal thread 3-1 of the safety cap 3. Thus, even if the pressure cooker 5 is operated for a relatively long time, the steam pipe 2 is not removed from the pressure cooker 5.

Therefore, the steam discharge device installed on the pressure cooker performs a steam discharge operation while the pressure cooker is operated.

However, when it is required to remove impurities from the safety cap, the safety cap is relatively firmly coupled to the steam pipe through a screw-type fastening method, so that it is difficult to disengage the threads of the steam pipe and the safety cap from each other. Further, when the safety cap is released from the steam pipe which is fastened to the lid of the pressure cooker, the steam pipe is also removed from the lid of the pressure cooker. That is, when the steam pipe is removed from the lid of the pressure cooker, the pressure cooker may be damaged. Further, when the steam pipe, removed from the lid, becomes lost, the pressure cooker is not usable any more.

### DISCLOSURE OF INVENTION

Technical Problem

Accordingly, the present invention has been made keeping in mind the above problems occurring in the prior art, and an object of the present invention is to provide a steam discharge device for pressure cookers, which is constructed so that a steam pipe is fastened to a lid of the pressure cooker using a fastening nut, and a safety cap is detachably fastened to the fastening nut via an O-ring fitted over the outer circumference of the fastening nut, thus enlarging the space for discharging steam from the interior of the pressure cooker, therefore reducing dangers, such as the risk of explosion.

Technical Solution

In order to accomplish the object, the present invention provides a steam discharge device for pressure cookers, including a steam pipe having a first steam discharge passage defined in the steam pipe, an external thread provided on an outer circumference of an end of the steam pipe, and a locking step provided on a middle of the steam pipe; a fastening nut having a second steam discharge passage defined in the fastening nut, and an internal thread provided at a predetermined position in the fastening nut and engaging with the external thread of the steam pipe; a safety cap having a nut receiving space defined at a predetermined position in the safety cap, and a plurality of slots provided at a predetermined position on the safety cap and causing the nut receiving space to communicate with an exterior; and an O-ring positioned between the fastening nut and the safety cap and preventing the safety cap from being removed from the fastening nut.

Advantageous Effects

As described above, a steam discharge device for pressure cookers according to this invention is constructed so that a safety cap is detachably fastened to a fastening nut via an O-ring fitted over the outer circumference of the fastening nut, thus allowing the safety cap to be easily removed from the fastening nut and cleaned when a pressure cooker becomes dirty with impurities, therefore keeping the pressure cooker clean. That is, when it is required to remove impurities from the safety cap, in the case of the steam discharge device for pressure cookers according to this invention, only the safety cap is removed from a pressure cooker while the steam pipe is secured to the pressure cooker. Thus, the steam discharge device of this invention is capable of preventing the pressure cooker from being damaged due to the steam pipe, and preventing the steam pipe from becoming lost, unlike a conventional steam discharge device for pressure cookers that must separate a steam pipe from a pressure cooker so as to clean impurities.

Further, the present invention provides a steam discharge device for pressure cookers, which is constructed so that a safety cap covers a fastening nut, thus preventing a steam discharge passage of a steam pipe fastened to the fastening nut from being blocked due to impurities, therefore preventing explosions or similar dangers.

### BRIEF DESCRIPTION OF THE DRAWINGS

FIG. 1 is a view to show a conventional steam discharge device for pressure cookers;

FIG. 2 is a view to show the conventional steam discharge device installed on a pressure cooker;

FIG. 3 is an exploded sectional view to show a steam discharge device for pressure cookers, according to the present invention;

FIG. 4 is a sectional view to show the steam discharge device for pressure cookers, according to this invention; and

FIG. 5 is a view to show the steam discharge device installed on a pressure cooker, according to this invention.

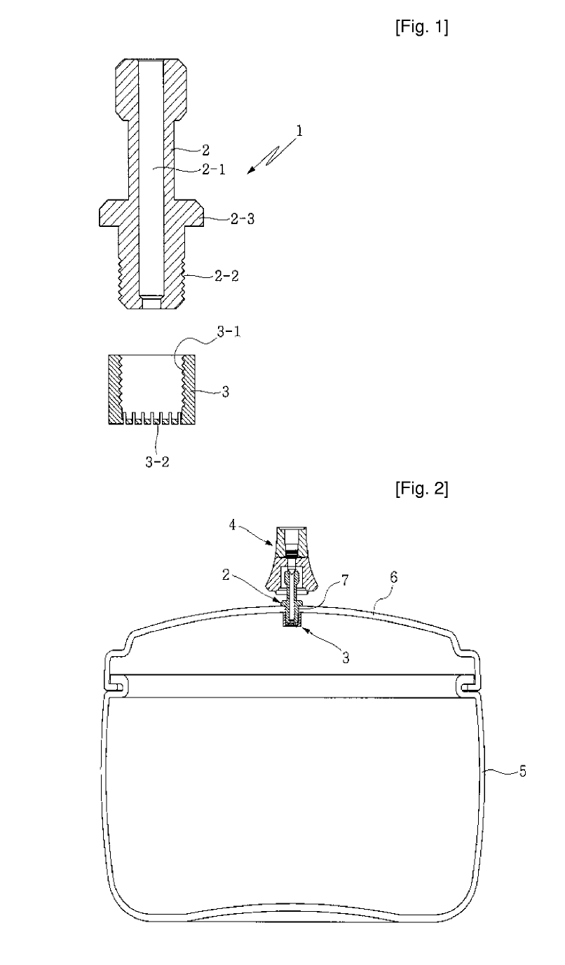

### BEST MODE FOR CARRYING OUT THE INVENTION

Hereinafter, a steam discharge device for pressure cookers, according to the preferred embodiment of the present invention, will be described with reference to the accompanying drawings.

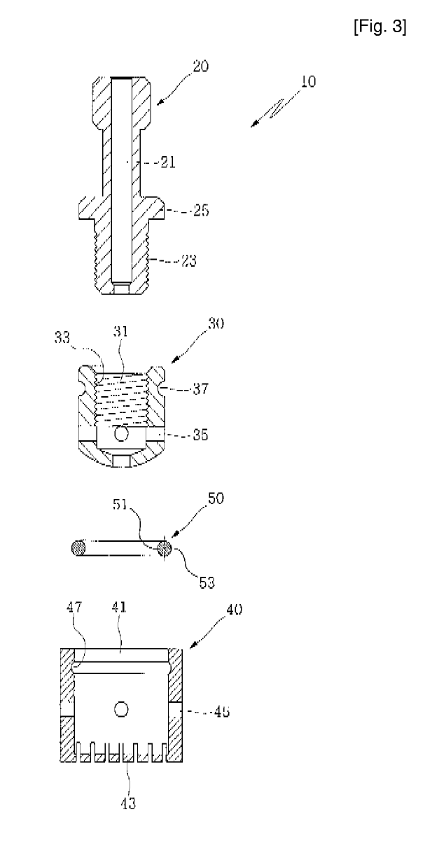

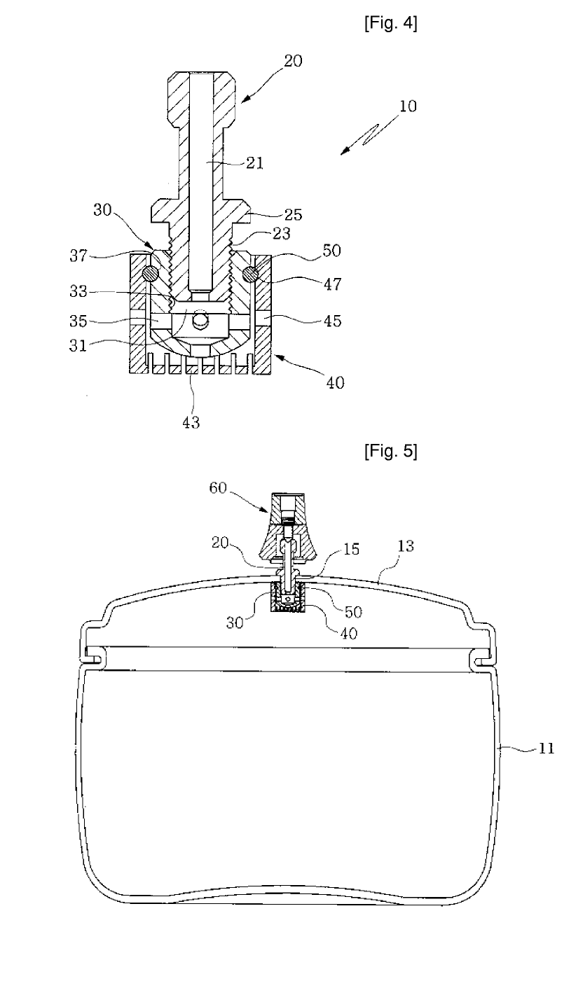

FIG. 3 is an exploded sectional view to show a steam discharge device for pressure cookers, according to the present invention, FIG. 4 is a sectional view to show the steam discharge device for pressure cookers, according to this invention, and FIG. 5 is a view to show the steam discharge device installed on a pressure cooker, according to this invention.

As shown in FIGS. 3 to 5, a steam discharge device 10 for pressure cookers according to this invention includes a steam pipe 20, a fastening nut 30, a safety cap 40, and an O-ring 50. The steam pipe 20 is inserted into a mounting hole 15 which is formed on a lid 13 of a pressure cooker 11, with a steam discharge passage 21 being defined in the steam pipe 20 to discharge steam, produced in the pressure cooker 11, to the exterior. The fastening nut 30 fastens the steam pipe 20 to the lid 13 of the pressure cooker 11. The safety cap 40 is coupled to the fastening nut 30 so as to prevent impurities, such as grains of boiled rice, from being caught in the steam discharge passage 21 of the steam pipe 20. The O-ring 50 is interposed between the fastening nut 30 and the safety cap 40, thus preventing the safety cap 40 from being removed from the fastening nut 30.

In a detailed description, the steam pipe 20 has the steam discharge passage 21 therein to discharge steam produced in the pressure cooker 11 to the exterior. An external thread 23 is provided on an outer circumference of an end of the steam pipe 20, and a locking step 25 is provided on a middle of the steam pipe 20.

The fastening nut 30 has a steam discharge passage 31 therein to discharge steam out of the pressure cooker 11. An internal thread 33 is provided at a predetermined position in the fastening nut 30, and engages with the external thread 23 of the steam pipe 20. At least one hole 35 is formed on a wall of the fastening nut 30, and causes the steam discharge passage 31 to communicate with the exterior.

Further, a ring seating recess 37 is formed on an outer circumference of the fastening nut 30 so that the O-ring 50 is seated in the ring seating recess.

The safety cap 40 has a nut receiving space 41 therein so that the fastening nut 20 is inserted from a first end of the safety cap 40 into the nut receiving space 41. A plurality of slots 43 is formed on a second end of the safety cap 40 in such a way as to communicate with the nut receiving space 41. At least one hole 45 is formed on a wall of the safety cap 40, and enables the nut receiving space 41 to communicate with the exterior.

In this case, the slots 43 are formed at proper intervals to prevent impurities, such as grains of boiled rice, from entering the steam discharge passages 21 and 31.

Further, a ring seating recess 47 is provided on an inner circumference of the nut receiving space 41 so that the O-ring 50 is seated in the ring seating recess 47.

After the O-ring 51 is fitted over the fastening nut 30 such that an inside part 51 of the O-ring 50 contacts the ring seating recess 37 formed on the outer circumference of the fastening nut 30, an outside part 53 of the O-ring 50 is seated in the ring seating recess 47 which is formed on the inner circumference of the safety cap 40. Thereby, the safety cap 40 and the fastening nut 30 are coupled to each other while the O-ring 50 is interposed between the safety cap 40 and the fastening nut 30.

The method of installing the steam discharge device 10 constructed as described above on the pressure cooker 11 will be described below.

First, a pressure regulator 60 is installed on an upper portion of the steam pipe 20. The lower portion of the steam pipe 20 having the external thread 23 is inserted into the mounting hole 15 such that the locking step 25 of the steam pipe 20 is stopped by the mounting hole 15 which is formed on the lid 13 of the pressure cooker 11.

Meanwhile, the O-ring 50 is seated in the ring seating recess 37 formed on the outer circumference of the fastening nut 30. The internal thread 33 of the fastening nut 30, over which the O-ring 50 is fitted, engages with the external thread 23 provided on the lower portion of the steam pipe 20 passing through the mounting hole 15. Thereby, the steam pipe 20 is secured to the lid 13 of the pressure cooker 11.

Next, the safety cap 40 is coupled to the fastening nut 30 such that the fastening nut 30 is accommodated in the nut receiving space 41 of the safety cap 40. That is, the safety cap 40 is coupled to the fastening nut 30, while the outside part 53 of the O-ring 50 is seated in the ring seating recess 47 formed on the nut receiving space 41 of the safety cap 40.

Therefore, when the pressure cooker equipped with the steam discharge device constructed as described above is operated, the steam discharge device discharges steam produced in the pressure cooker to the exterior.

1. A steam discharge device for pressure cookers, comprising:
a steam pipe, comprising:
a first steam discharge passage defined in the steam pipe;
an external thread provided on an outer circumference of an end of the steam pipe; and
a locking step provided on a middle of the steam pipe;
a fastening nut, comprising:
a second steam discharge passage defined in the fastening nut; and
an internal thread provided at a predetermined position in the fastening nut, and engaging with the external thread of the steam pipe;
a safety cap, comprising:
a nut receiving space defined at a predetermined position in the safety cap, and
receiving the fastening nut therein; and
a plurality of slots provided at a predetermined position on the safety cap, and
enabling the nut receiving space to communicate with an exterior; and
an O-ring positioned between the fastening nut and the safety cap, and
preventing the safety cap from being removed from the fastening nut.

2. The steam discharge device according to claim 1, wherein the fastening nut comprises:
a ring seating recess provided on an outer circumference of the fastening nut, and having a predetermined depth to accommodate the O-ring.

3. The steam discharge device according to claim 2, wherein the safety cap comprises:
a ring seating recess provided on an inner circumference of the safety cap, and having a predetermined depth to accommodate the O-ring.

4. The steam discharge device according to claim 1, wherein the safety cap comprises:
a ring seating recess provided on an inner circumference of the safety cap, and having a predetermined depth to accommodate the O-ring.

5. The steam discharge device according to claim 1, wherein the fastening nut comprises:
at least one hole provided on a sidewall of the fastening nut in such a way as to communicate with the second steam discharge passage.

6. The steam discharge device according to claim 5, wherein the fastening nut comprises:
a ring seating recess provided on an outer circumference of the fastening nut, and having a predetermined depth to accommodate the O-ring.

7. The steam discharge device according to claim 6, wherein the safety cap comprises:
a ring seating recess provided on an inner circumference of the safety cap, and having a predetermined depth to accommodate the O-ring.

8. The steam discharge device according to claim 5, wherein the safety cap comprises:
a ring seating recess provided on an inner circumference of the safety cap, and having a predetermined depth to accommodate the O-ring.

9. The steam discharge device according to claim 5, wherein the safety cap comprises:
at least one hole provided on a sidewall of the safety cap, and enabling the nut receiving space to communicate with the exterior.

10. The steam discharge device according to claim 9, wherein the fastening nut comprises:
a ring seating recess provided on an outer circumference of the fastening nut, and having a predetermined depth to accommodate the O-ring.

11. The steam discharge device according to claim 10, wherein the safety cap comprises:
a ring seating recess provided on an inner circumference of the safety cap, and having a predetermined depth to accommodate the O-ring.

12. The steam discharge device according to claim 9, wherein the safety cap comprises:
a ring seating recess provided on an inner circumference of the safety cap, and having a predetermined depth to accommodate the O-ring.

13. The steam discharge device according to claim 1, wherein the safety cap comprises:
at least one hole provided on a sidewall of the safety cap, and enabling the nut receiving space to communicate with the exterior.

14. The steam discharge device according to claim 13, wherein the fastening nut comprises:
a ring seating recess provided on an outer circumference of the fastening nut, and having a predetermined depth to accommodate the O-ring.

15. The steam discharge device according to claim 14, wherein the safety cap comprises:
a ring seating recess provided on an inner circumference of the safety cap, and having a predetermined depth to accommodate the O-ring.

16. The steam discharge device according to claim 13, wherein the safety cap comprises:
a ring seating recess provided on an inner circumference of the safety cap, and having a predetermined depth to accommodate the O-ring.
